(19) United States
(12) Patent Application Publication
(10) Pub. No.: US 2026/0230100 A1
(43) Pub. Date: Aug. 6, 2026

(54) SECTOR POWER POOLING

(71) Applicant: Telefonaktiebolaget LM Ericsson (publ), Stockholm (SE)

(72) Inventors: Magnus STORE, Uppsala (SE); Anders PERS, Åkersberga (SE); Ari-Pekka SALOVAARA, Solna (SE)

(73) Assignee: Telefonaktiebolaget LM Ericsson (publ), Stockholm (SE)

(21) Appl. No.: 19/146,264

(22) PCT Filed: Jun. 28, 2023
(86) PCT No.: PCT/SE2023/050669

§ 371 Date: Jul. 8, 2025

Related U.S. Application Data
(60) Provisional application No. 63/444,756, filed on Feb. 10, 2023.

(51) Int. Cl. H04B 1/04

(52) U.S. Cl. CPC H04B 1/0483; H04B 1/0475; H04B 2001/0408

(57) ABSTRACT

A multi-band transmitter can include a first antenna port, a second antenna port, and a multi-band power amplifier. The first antenna port can be associated with a first sector of a coverage area. The second antenna port can be associated with a second sector of the coverage area. The second antenna port can be different from the first antenna port and the second sector can be different from the first sector. The multi-band power amplifier can be configured to generate an output that includes: a first portion that is associated with a first frequency band and that is routed to the first antenna port; and a second portion that is associated with a second frequency band and that is routed to the second antenna port. The second frequency band can be different than the first frequency band.

### TECHNICAL FIELD

The present disclosure is related to wireless communication systems and more particularly to sector power pooling.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)). The innovations described herein can be used with any suitable radio access technology (“RAT”) including current RATs (e.g., second generation (“2G”), third generation (“3G”), and fourth generation (“4G”)) and future RATs (e.g., sixth generation (“6G”)).

The coverage area of a network node can be divided into one or more sectors. A network node can include a radio transceiver including hardware for communicating with one or more communication devices in each of the one or more sectors. In some examples, the hardware includes a multi-band transmitter configured to transmit using one or more frequency bands. The multi-band transmitter can include a multi-band amplifier that amplifies a signal carrying information in multiple bands. Each frequency band of the amplified signal of the multi-band power amplifier are communicatively coupled to a common antenna port. In some examples, the antenna port is an interface between the multi-band power amplifier and an antenna configured to communicate with one sector of the coverage area. A radio transceiver and/or multi-band transmitter can include multiple multi-band power amplifiers. For example, a multi-band transmitter can include a first multi-band power amplifier with an output communicatively coupled to a first antenna port and a second multi-band power amplifier with an output communicatively coupled to a second antenna port. The first antenna port and the second antenna port can each be associated with different antennas that are associated with the same (or different) sectors of the coverage area.

The output power of a signal being transmitted by a multi-band transmitter can be limited by an amount of power being provided by a corresponding multi-band power amplifier. A higher output power can be desired in order to reach more communication devices and/or to improve signal quality.

### SUMMARY

According to some embodiments, a multi-band transmitter (also referred to herein as a radio or a radio transmitter) in a communications network is provided. The multi-band transmitter includes a first antenna port, a second antenna port that is different from the first antenna port, and a multi-band power amplifier. The first antenna port is associated with a first sector of a coverage area. The second antenna port is associated with a second sector of the coverage area, the second sector being different from the first sector. The multi-band power amplifier is configured to generate an output that includes a first portion of the output and a second portion of the output. The first portion of the output is associated with a first frequency band and is routed to the first antenna port. The second portion of the output is associated with a second frequency band and is routed to the second antenna port. The second frequency band is different than the first frequency band.

According to other embodiments, a multi-band transmitter is provided. The multi-band transmitter includes a plurality of wideband signal sources each configured to provide a plurality of frequency bands. The multi-band transmitter further includes routing circuitry configured to route each frequency band of the plurality of frequency bands associated with one of the plurality of wideband signal sources to a different wideband signal consumer. Each of the different wideband signal consumers are associated with a different coverage area of the multi-band transmitter.

According to other embodiments, a method of operating a network node in a communications network is provided. The method includes determining to transmit data towards a sector of the communications network. The method further includes providing a first portion of the data in a first frequency band to a first multi-band power amplifier. The method further includes providing a second portion of the data in a second frequency band to a second multi-band power amplifier. The second frequency band is different than the first frequency band. The second multi-band power amplifier is different than the first multi-band power amplifier.

According to other embodiments, a method of operating a network node to pool power between a plurality of multi-band power amplifiers is provided. The method includes determining that a first sector of a coverage area of the network node has a greater load than a second sector of the coverage area of the network node. The method further includes adjusting an amount of power used by a multi-band power amplifier for a first frequency band relative to an amount of power used by the multi-band power amplifier for a second frequency band based on determining that the first sector has a greater load than the second sector.

According to other embodiments, a multi-band transmitter, a radio, a radio transmitter, a network node, a host, a system, a computer program, a computer program product, or a non-transitory computer readable medium is provided for performing one of the above methods.

Certain embodiments may provide one or more of the following technical advantages. In some embodiments, a radio transmitter is able to pool power from multiple multi-band power amplifiers to increase the power being used for transmissions to a specific sector. This can allow a multi-band transmitter to better use the total power provided by the multi-band power amplifiers and in turn lead to smaller radios with better efficiency, lower power consumption, and improved sustainability (e.g., less of an environmental footprint).

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5th generation (“5G”) network;

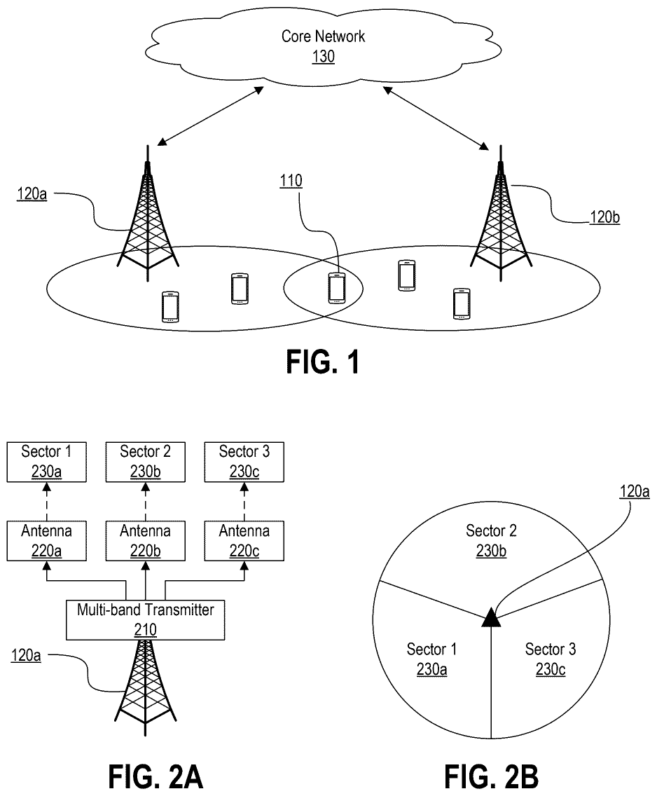

FIG. 2A is a schematic diagram illustrating an example of a three-sector network node with one antenna for each sector;

FIG. 2B is a schematic diagram illustrating an example of the three sectors associated with the three-sector network node of FIG. 2A;

FIG. 3 is a block diagram illustrating an example of a radio transmitter without sector power pooling;

FIGS. 4-8 are block diagrams illustrating examples of different radio transmitters that each support sector power pooling by routing outputs of multi-band power amplifiers to different antenna ports in accordance with some embodiments;

FIGS. 9-11 are block diagrams illustrating examples of filter boxes in accordance with some embodiments;

FIG. 12 is a block diagram illustrating an example of a radio transmitter including the filter box illustrated in FIG. 10 in accordance with some embodiments;

FIG. 13 is a block diagram illustrating an example of a radio transmitter including the filter box illustrated in FIG. 11 in accordance with some embodiments;

FIGS. 14-15 are flow charts illustrating examples of operations performed by a radio transmitter in accordance with some embodiments;

FIG. 16 is a block diagram of a communication system in accordance with some embodiments;

FIG. 17 is a block diagram of a user equipment in accordance with some embodiments;

FIG. 18 is a block diagram of a network node in accordance with some embodiments;

FIG. 19 is a block diagram of a host computer communicating with a user equipment in accordance with some embodiments;

FIG. 20 is a block diagram of a virtualization environment in accordance with some embodiments; and

FIG. 21 is a block diagram of a host computer communicating via a base station with a user equipment over a partially wireless connection in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

There currently exist certain challenges associated with multi-band transmitters that include a multi-band power amplifier. In some examples, it is expensive and/or difficult to design and/or operate the multi-band power amplifier such that the multi-band power amplifier provides enough power to a corresponding antenna and/or coverage area particularly during high traffic while maintaining an acceptable signal quality.

Certain aspects of the disclosure and their embodiments may provide solutions to these or other challenges. Transmitters for multiple frequency bands have traditionally used a separate power amplifier for each different frequency band. Each amplifier was capable of a maximum power output. Wideband power amplifiers (also referred to herein as multi-band power amplifiers) allow several different frequency bands to be amplified by a single amplifier. The maximum power that a multi-band power amplifier can output is typically a total for all the bands. As a result, there is no longer a per-band maximum power but instead a total maximum power such that the sum of the power output for all frequency bands is subject to a limit.

In some examples, the total power available to a radio transmitter is inefficiently divided between power amplifiers. For example, each power amplifier in a radio transmitter may be dimensioned for “worst case” traffic load, which can require a minimum power be provided to each power amplifier. However, due to a limited total available power and a minimum power required to be provided to each power amplifier, there are instances when some power amplifiers are lacking power (overbooking) due to high traffic load in their corresponding sector while other power amplifiers, corresponding to other sectors, are idling. This results in an unbalanced and inefficient power utilization.

Accordingly, sector power can be limited by the dedicated power amplifiers predetermined by the hardware design. When one sector has high traffic load and requires higher power, it would be beneficial to be able to use the power being provided by other power amplifiers.

In some embodiments, a multi-band power amplifier is configured to serve multiple sectors. For example, a dual-band power amplifier can be configured to serve two sectors by routing different portions of the output of the dual-band transmitter (e.g., one portion for each frequency band) to separate antenna ports associated with different sectors. The portion of the output corresponding to the first frequency band can be routed to an antenna port serving a first sector. The portion of the output corresponding to the second frequency band (of the same dual-band power amplifier) can be routed to an antenna port serving the second sector.

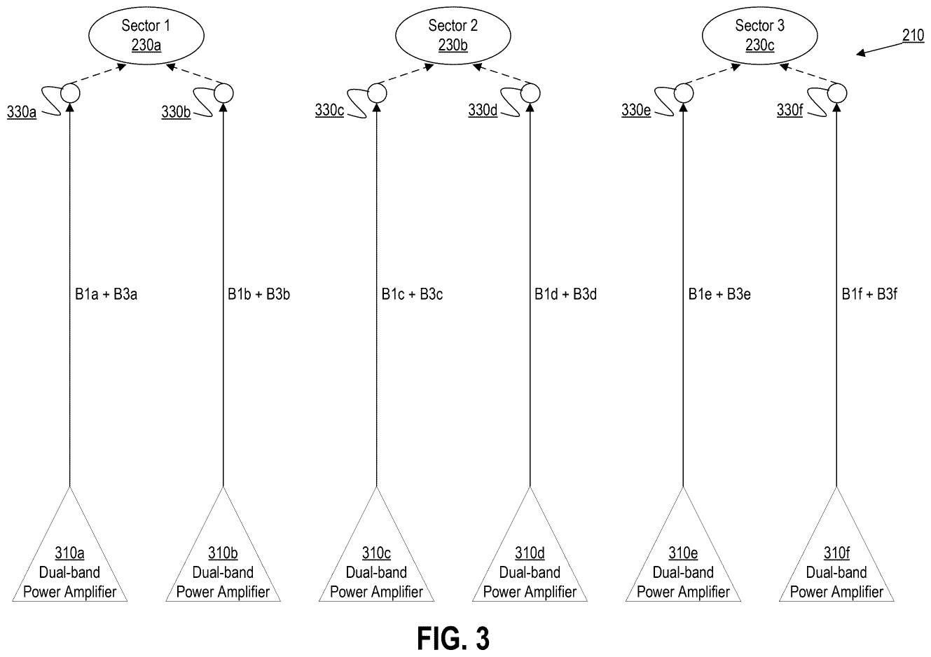

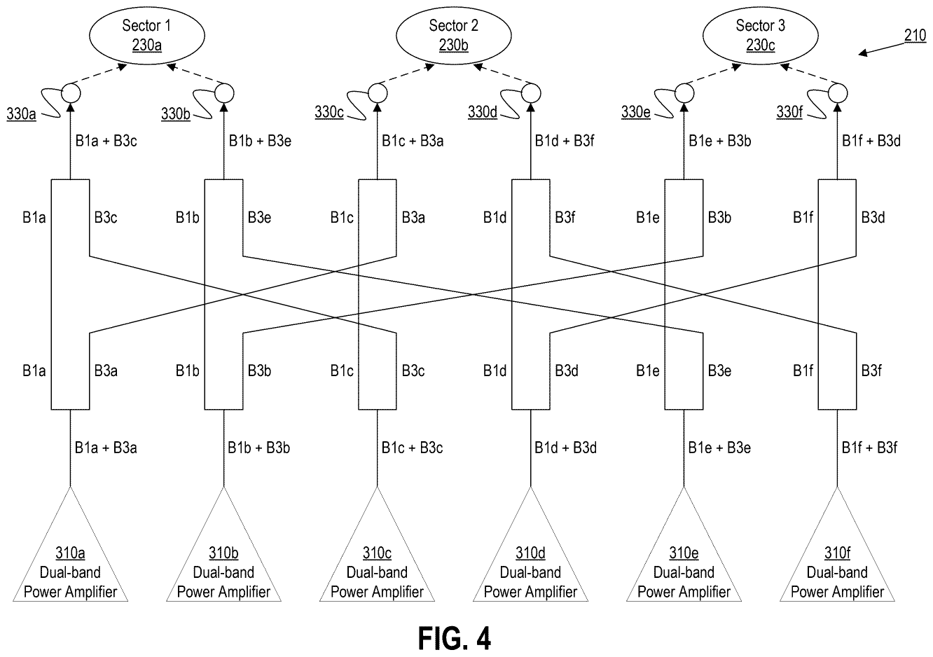

FIG. 2A illustrates an example of a three-sector network node 120a (e.g., a radio tower or base station) that includes a multi-band transmitter 210 (with three antenna ports) communicatively coupled with three antennas 220a-c that are each associated with one of three sectors 230a-c of a coverage area of the radio transmitter 210 (also referred to herein as a multi-band transmitter). FIG. 2B illustrates an example of the three sectors 230a-c associated with the three-sector network node 120a of FIG. 2A. As illustrated, in some examples, the radio transmitter 210 is configured to link the antennas 220a-c with processing circuitry of the network node 120a.

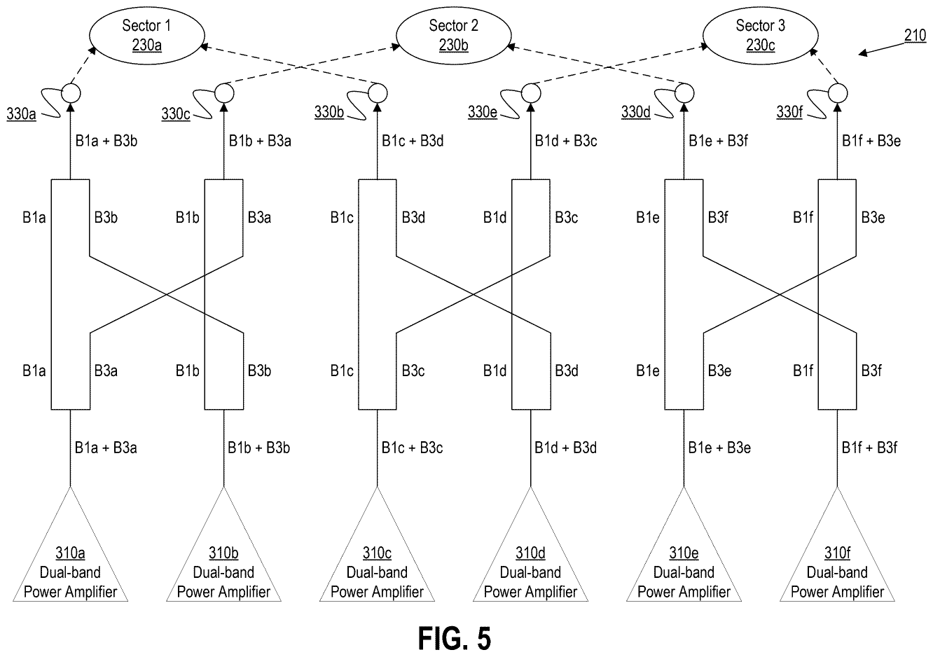

FIG. 3 illustrates an example of the radio transmitter 210 that can be included in the network node 120a illustrated in FIGS. 2A-B. The radio transmitter 210 can include six dual-band power amplifiers 310a-f and six antenna ports 330a-f (two antenna ports corresponding to each of the three sectors 230a-c). Each of the six dual-band power amplifiers 310a-f can include an output (e.g., B1a+B3b, B1b+B3b, B1c+B3c, B1d+B3d, B1e+B3e, and B1f+B3f) that is routed to an antenna port 330a-f. Each output can be described as including two portions each being associated with a different frequency band (e.g., frequency band 1 (“B1”) and frequency band 3 (“B3”). In this configuration, there is one dual-band power amplifier 310a-f coupled with each of the six antenna ports 330a-f such that there are two dual-band power amplifiers 310a-f associated with transmissions to each of the sectors 230a-c. This configuration can be referred to as two antennas for transmitting and two antennas for receiving (“2T2R”) per sector. In some examples, the two antenna ports associated with a sector can each be communicatively coupled to a dual-polarized antenna that can wirelessly transmit to one or more devices in the corresponding sector. One of the antenna ports can provide a signal (including both frequency bands that are each routed from a first dual band power amplifier) to be used as a first polarization and the other of the antenna ports can provide a signal (including both frequency bands that are each routed from a second dual band power amplifier) to be used as a second polarization.

In this example, there are two dual-band power amplifiers 310a-b serving sector 1 230a via antenna ports 330a-b, two dual-band power amplifiers 310c-d serving sector 2 230b via antenna ports 330c-d, and two dual-band power amplifiers 310e-f serving sector 3 230c via antenna ports 330e-f. Each of the dual-band power amplifiers 310a-f support frequency bands B1 and B3. Dual-band power amplifier 310a outputs an output B1a+B3a (also referred to herein as a signal) that includes a portion associated with frequency band 1 (B1a) and a portion associated with frequency band 3 (B3a). Dual-band power amplifier 310b outputs an output B1b+B3b that includes a portion associated with frequency band 1 (B1b) and a portion associated with frequency band 3 (B3b). Dual-band power amplifier 310c outputs an output B1c+B3c that includes a portion associated with frequency band 1 (B1c) and a portion associated with frequency band 3 (B3c). Dual-band power amplifier 310d outputs an output B1d+B3d that includes a portion associated with frequency band 1 (B1d) and a portion associated with frequency band 3 (B3d). Dual-band power amplifier 310e outputs an output B1e+B3e that includes a portion associated with frequency band 1 (B1e) and a portion associated with frequency band 3 (B3e). Dual-band power amplifier 310f outputs an output B1f+B3f that includes a portion associated with frequency band 1 (B1f) and a portion associated with frequency band 3 (B3f). All six antenna ports 330a-f receive a signal (e.g., a portion of the output of a dual-band power amplifier 310a-f) associated with each of B1 and B3. Although not illustrated in FIG. 3, the signal quality of the output of each dual-band power amplifier 310a-f may be improved by filtering the output. In some examples (not illustrated), the output is passed through a filter before it is provided to the corresponding antenna port.

In this example, each dual-band power amplifier 310a-f may provide at most a predetermined and/or limited amount of power regardless of the instantaneous actual load on each sector 230a-c. As a result, the maximum power that can be used for transmitting to each sector 230a-c is based on the limited amount of power provided by the corresponding two dual-band power amplifiers 310a-f.

Various embodiments described herein enable sector power pooling such that more power can be provided to a sector (e.g., if there is a heavy load on one sector while another sector is idling). In some embodiments, sector power pooling can be enabled by routing different portions (corresponding to different frequency bands) of the output of a multi-band power amplifier to different antenna ports.

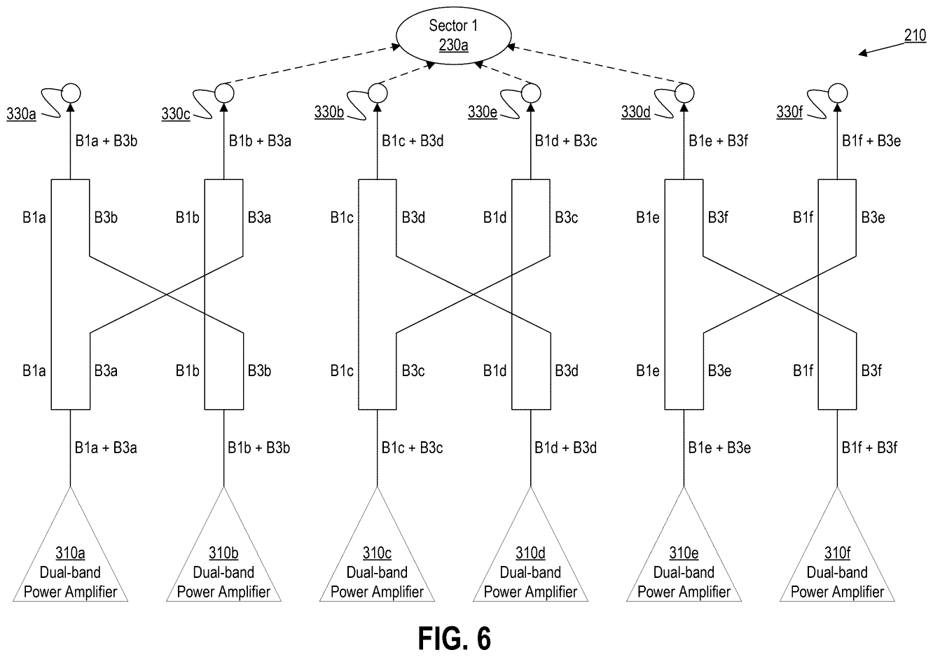

FIG. 4 illustrates an example of how the different portions of the output of a dual-band power amplifier 310a-f (corresponding to the two frequency bands B1 and B3) can be routed to different antenna ports 330a-f. In this example, one dual band power amplifier 310a is serving two sectors 230a-b, B1 in one sector 230a and B3 in another sector 230b. As in FIG. 3, antenna ports 330a-b serve sector 1 230a, antenna ports 330c-d serve sector 2 230b, and antenna ports 330e-f serve sector 3 230c. All six of the antenna ports 330a-f include both B1 and B3 with signals from different dual-band power amplifiers. With this configuration there are four different power amplifiers serving each sector. In some examples, if there is high traffic load in sector 1 (antenna ports 330a-b), this configuration enables the radio transmitter to use power from four power amplifiers 310a-c and 310e to serve sector 1 230a. In this way, power can be pooled from more power amplifiers to increase the output power to a high load sector.

In this example, the output of each dual-band power amplifier 310a-f is split (e.g., by a splitter) into portions associated with different frequency bands and are routed to an antenna port 330a-f (e.g., via a combiner that combines different frequency bands from different power amplifiers). Although FIGS. 4-7 are each illustrated as directly routing a portion of the output of each power amplifier to an antenna port, the path between a dual-band power amplifier and an antenna port can include any suitable elements (e.g., a filter box as illustrated in FIG. 8). Furthermore, although FIGS. 4-8 are illustrated as using dual-band power amplifiers similar routing can be used with multi-band power amplifiers (e.g., multi-band power amplifiers with more than two bands). In some examples, each frequency band (also referred to herein as each portion of the output) of a multi-band power amplifier is routed to an antenna port associated with a different sector. In additional or alternative examples, portions of an output of a multi-band transmitter that correspond to different frequency bands (but not all portions of the output) are routed to different antenna ports that are each associated with a different sector.

FIG. 5 illustrates an alternative configuration for routing the outputs of each dual-band power amplifier 310a-f to different antenna ports 330a-f. As in FIGS. 3-4, antenna ports 330a-b serve sector 1 230a, antenna ports 330c-d serve sector 2 230b, and antenna ports 330e-f serve sector 3 230c. However, the antenna ports 330a-f are arranged (from left to right) as 330a, 330c, 330b, 330e, 330d, and 330f to reduce the number of cross connections. Any routing of the outputs of the multi-band power amplifiers 310a-f to different antenna ports 330a-f can enable sector power pooling.

In additional or alternative embodiments, a network node may be configured to transmit to a single sector. FIG. 6 illustrates an example of a configuration for a radio transmitter 210 in a network node that is configured to transmit to a single sector (Sector 1 230a). In this example, similar to FIGS. 4-5, the radio transmitter includes six antenna ports 330a-f and six dual-band power amplifiers 310a-f. However, four of the antenna ports (330b, 330c, 330d, and 330e) are configured for transmission to the single sector and antenna ports 330a and 330f are not configured for transmission to any sector. This configuration can be referred to as four antennas for transmitting and four antennas for receiving (“4T4R”) per sector. In some examples each antenna port can be communicatively coupled to a dual-band antenna with dual inputs for each polarization.

In additional or alternative embodiments, a network node may be configured to transmit to two sectors. FIG. 7 illustrates an example of a configuration for a radio transmitter 210 in a network node that is configured to transmit to two sectors (1 and 2). In this example, similar to FIGS. 4-5, the radio transmitter 210 includes six antenna ports 330a-f and six dual-band amplifiers 310a-f. However, four of the antenna ports (330a-e) are configured for transmission to sector 1 230a and antenna ports 330a and 330f are configured for transmission to sector 2 230b. This configuration can be referred to as having 4T4R in one sector and 2T2R in another sector.

In additional or alternative embodiments, the innovations described above can be adapted for a network node configured to transmit to any number of sectors.

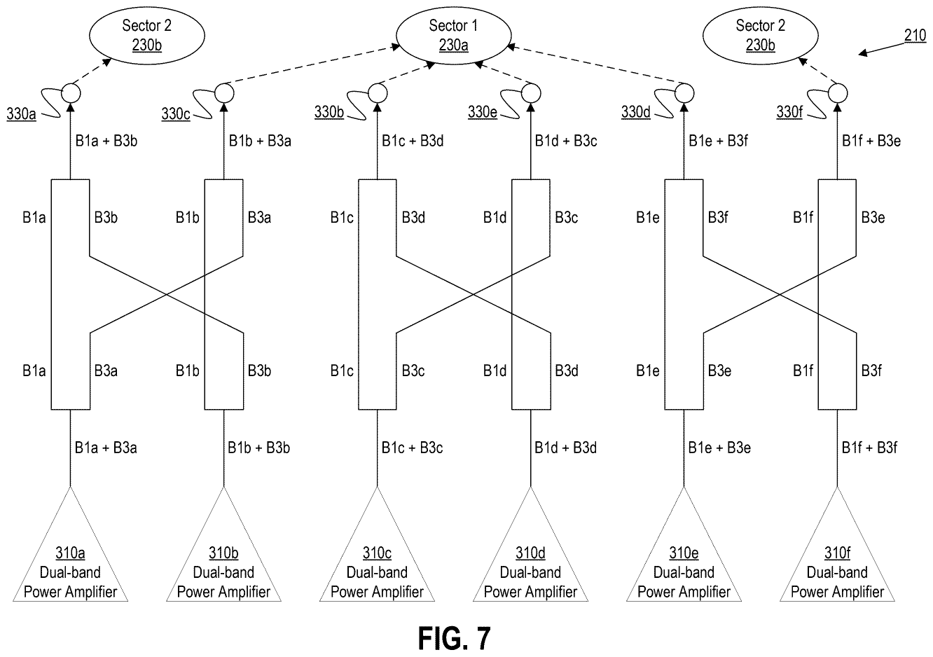

FIG. 8 illustrates an alternative configuration for routing the outputs of each dual-band power amplifier 310a-f to different antenna ports 330a-f. As in FIGS. 3-4, antenna ports 330a-b serve sector 1 230a, antenna ports 330c-d serve sector 2 230b, and antenna ports 330e-f serve sector 3 230c. Similar to FIG. 5, the antenna ports 330a-f are arranged (from left to right) as 330a, 330c, 330b, 330e, 330d, and 330f to reduce the number of cross connections. The output of each dual-band power amplifier 310a-f are routed to their respective antenna ports via a filter box 800. FIGS. 9-11 illustrate three examples of the filter box 800 as filter boxes 900, 1000, 1100 respectively.

Although FIGS. 4-8 illustrate embodiments in which a radio transmitter includes dual-band power amplifiers, the innovations can be adapted for any multi-band power amplifier. In additional or alternative embodiments, while the radio transmitter has been described as a single device within a single network node, the radio transmitter may be separated/divided among multiple devices. In additional or alternative embodiments, the network node and/or the radio transmitter may include the antennas coupled to the antenna ports.

FIG. 9 illustrates an example of a filter box 900 that can be used as part of a circuit for routing output of two dual-band power amplifiers to two antenna ports as illustrated in FIG. 8. In this example, the filter box 900 includes a pair of splitters 910, 960 and combiners 930, 980. Each splitter 910, 960 can have a splitter input port 912, 962 and two splitter output ports 914a-b, 964a-b. Each combiner 930, 980 can have two combiner input ports 932a-b, 982a-b and a combiner output port 934, 984. Splitter output port 914a can be communicatively coupled to combiner input port 932a. Splitter output port 914b can be communicatively coupled to combiner input port 982b. Splitter output port 964a can be communicatively coupled to combiner input port 982a. Splitter output port 964b can be communicatively coupled to combiner input port 932b.

The filter box 900 can receive an input signal at each of the splitter input ports 912, 962. Each of the input signals can correspond to an output from a different dual-band power amplifier and each of the input signals can include portions associated with different frequency bands (e.g., B1 and B3). Each splitter 912, 962 can split the input signal into two portions (e.g., corresponding to each frequency band) and output them on its corresponding splitter output port 914a-b, 964a-b. Based on the coupling between the splitters 910, 960 and the combiners 930, 980, each combiner 930, 980 can receive a portion of each input signal corresponding to different frequency bands. Each combiner 930, 980 can combine the portions received at its corresponding combiner input ports 932a-b, 982a-b (each portion corresponding to a different frequency band) into a combined signal that it can output on its combiner output port 934, 984, which can be communicatively coupled to an antenna port.

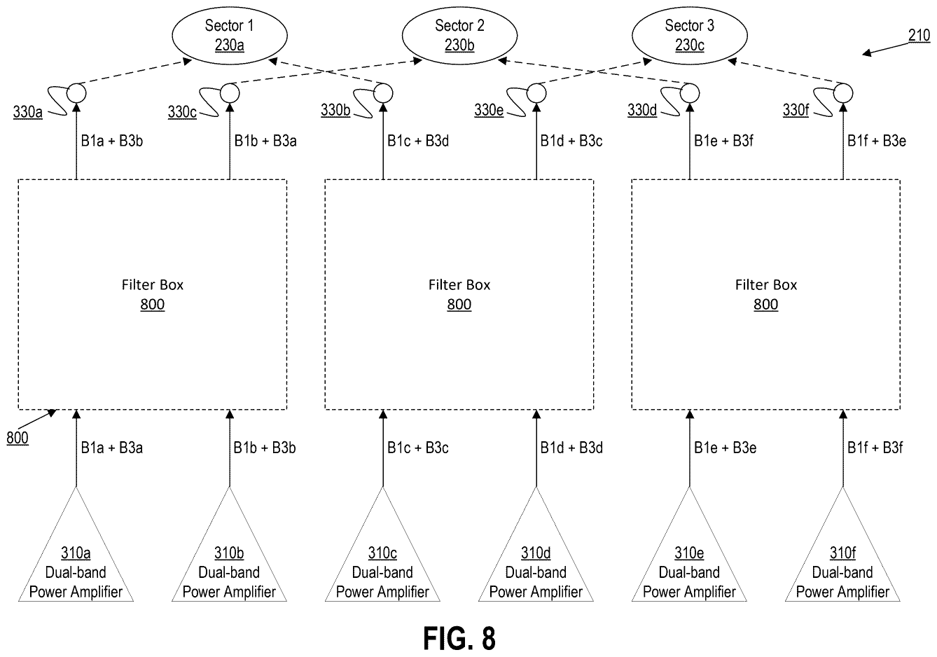

FIG. 10 illustrates an example of a filter box 1000 that can be used as part of a circuit for routing output of two dual-band power amplifiers to two antenna ports as illustrated in FIGS. 8 and 12. In this example, the filter box 1000 includes a pair of splitters 1010, 1060, combiners 1030, 1080, and filters 1020a-b, 1070a-b. Similarly to FIG. 9, each splitter 1010, 1060 can have a splitter input port 1012, 1062 and two splitter output ports 1014a-b, 1064a-b. Each combiner 1030, 1080 can have two combiner input ports 1032a-b, 1082a-b and a combiner output port 1034, 1084.

In contrast to FIG. 9, the splitters 1030, 1060 are communicatively coupled to the combiners 1030, 1080 via the filters 1020a-b, 1070a-b. Filters 1020a-b, 1070a-b each include a filter input port 1022a-b, 1072a-b and a filter output port 1024a-b, 1074a-b. Splitter output port 1014a can be communicatively coupled to filter input port 1022a and filter output port 1024a can be communicatively coupled to combiner input port 1032a. Splitter output port 1014b can be communicatively coupled to filter input port 1022b and filter output port 1024b can be communicatively coupled to combiner input port 1082b. Splitter output port 1064a can be communicatively coupled to filter input port 1072a and filter output port 1074a can be communicatively coupled to combiner input port 1082a. Splitter output port 1064b can be communicatively coupled to filter input port 1072b and filter output port 1074b can be communicatively coupled to combiner input port 1032b.

Similarly to filter box 900 in FIG. 9, the filter box 1000 can receive an input signal at each of the splitter input ports 1012, 1062. Each of the input signals can correspond to an output from a different dual-band power amplifier and each of the input signals can include portions associated with different frequency bands (e.g., B1 and B3). Each splitter 1012, 1062 can split the input signal into two portions (e.g., corresponding to each frequency band) and output them on its corresponding splitter output port 1014a-b, 1064a-b. The filters 1020a-b, 1072a-b can each receive a portion of one of the input signals corresponding to a frequency band and filter out frequencies outside of the corresponding frequency band. In some examples, the filters are band pass filters (e.g., a cavity branch filter). Each filter 1020a-b, 1072a-b can output a filtered version of their received signal on their filter output port 1024a-b, 1074a-b. Based on the coupling between the filters 1020a-b, 1070a-b and the combiners 1030, 1080, each combiner 1030, 1080 can receive a filtered portion of each input signal corresponding to different frequency bands. Each combiner 1030, 1080 can combine the filtered portions received at its corresponding combiner input ports 1032a-b, 1082a-b (each filtered portion corresponding to a different frequency band) into a combined signal that it can output on its combiner output port 1034, 1084, which can be communicatively coupled to an antenna port.

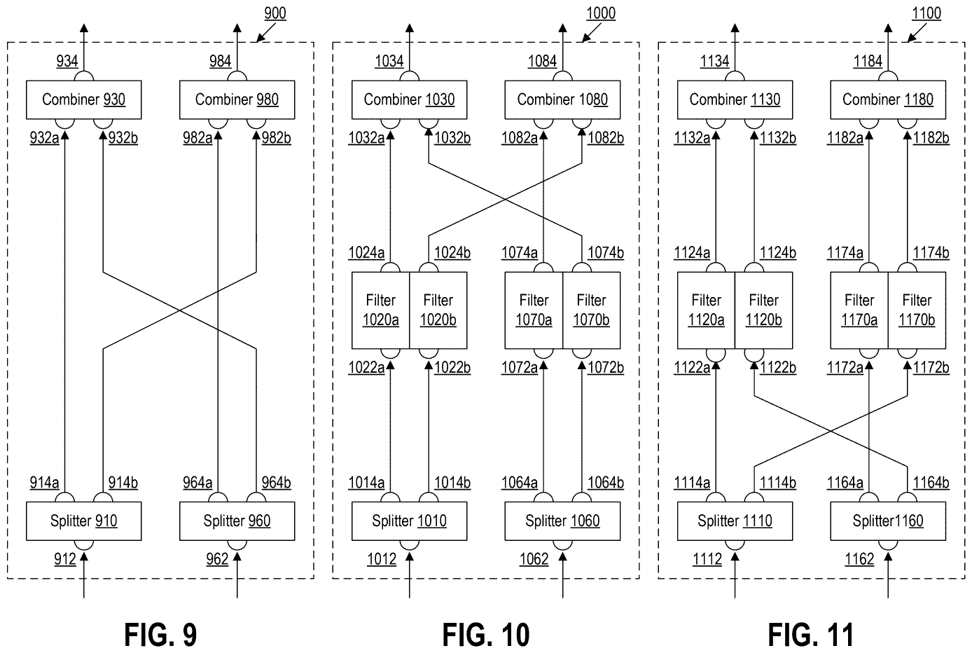

FIG. 11 illustrates an example of a filter box 1100 that can be used as part of a circuit for routing output of two dual-band power amplifiers to two antenna ports as illustrated in FIGS. 8 and 13. In this example, the filter box 1100 includes a pair of splitters 1110, 1160, combiners 1130, 1180, and filters 1120a-b, 1170a-b. Similarly to FIGS. 9-10, each splitter 1110, 1160 can have a splitter input port 1112, 1162 and two splitter output ports 1114a-b, 1164a-b. Each combiner 1130, 1180 can have two combiner input ports 1132a-b, 1182a-b and a combiner output port 1134, 1184.

Similar to FIG. 10, the splitters 1130, 1160 are communicatively coupled to the combiners 1130, 1180 via the filters 1120a-b, 1170a-b. Filters 1120a-b, 1170a-b each include a filter input port 1122a-b, 1172a-b and a filter output port 1124a-b, 1174a-b. Splitter output port 1114a can be communicatively coupled to filter input port 1122a and filter output port 1124a can be communicatively coupled to combiner input port 1132a. Splitter output port 1164a can be communicatively coupled to filter input port 1172a and filter output port 1174a can be communicatively coupled to combiner input port 1182a.

In contrast to FIG. 10, splitter output port 1114b can be communicatively coupled to filter input port 1172b and filter output port 1174b can be communicatively coupled to combiner input port 1082b. Also in contrast to FIG. 10, splitter output port 1164b can be communicatively coupled to filter input port 1122b and filter output port 1124b can be communicatively coupled to combiner input port 1132b.

Similarly to filter box 1000 in FIG. 10, the filter box 1100 can receive an input signal at each of the splitter input ports 1112, 1162. Each of the input signals can correspond to an output from a different dual-band power amplifier and each of the input signals can include portions associated with different frequency bands (e.g., B1 and B3). Each splitter 1112, 1162 can split the input signal into two portions (e.g., corresponding to each frequency band) and output them on its corresponding splitter output port 1114a-b, 1164a-b. The filters 1120a-b, 1172a-b can each receive a portion of one of the input signals corresponding to a frequency band and filter out frequencies outside of the corresponding frequency band. In some examples, the filters are band pass filters (e.g., a cavity branch filter). Each filter 1120a-b, 1172a-b can output a filtered version of their received signal on their filter output port 1124a-b, 1174a-b. Based on the coupling between the filters 1120a-b, 1170a-b and the combiners 1130, 1180, each combiner 1130, 1180 can receive a filtered portion of each input signal corresponding to different frequency bands. Each combiner 1130, 1180 can combine the filtered portions received at its corresponding combiner input ports 1132a-b, 1182a-b (each filtered portion corresponding to a different frequency band) into a combined signal that it can output on its combiner output port 1134, 1184, which can be communicatively coupled to an antenna port.

Each of the filter boxes 800, 900, 1000, 1100 of FIGS. 8-11 can receive a first input signal and a second input signal that each include a first portion associated with a first frequency band and a second portion associated with a second frequency band. Each of the filter boxes 800, 900, 1000, 1100 of FIGS. 8-11 can output a first output signal (including a first portion of the first input signal and a second portion of the second input signal) and a second output signal (including a first portion of the second input signal and a first portion of the second input signal). Although FIGS. 8-11 illustrate examples of filter boxes 800, 900, 1000, 1100 for use with dual-band power amplifiers similar filter boxes (e.g., with more splitters, filters, and/or combiners) can be used to handle any multi-band power amplifier.

FIG. 12 illustrates an example of the radio transmitter 210 of FIG. 8 with a filter box 800 further illustrated by filter box 1000. As illustrated, dual-band power amplifier 310a can output B1a+B3a (which includes a first portion B1a associated with frequency B1 and a second portion B3a associated with frequency B3) and dual-band power amplifier 310b can output B1b+B3b (which includes a first portion B1b associated with frequency B1 and a second portion B3b associated with frequency B3).

Splitter 1010 can split the output B1a+B3a into the first portion B1a and the second portion B3a, provide the first portion B1a to filter 1020a, and provide the second portion B3a to filter 1020b. Filter 1020a can filter out frequencies outside of B1 from the first portion B1a and output the filtered first portion B1a′ to combiner 1030. Filter 1020b can filter out frequencies outside of B3 from the second portion B3a and output the filtered second portion B3a′ to combiner 1080.

Splitter 1060 can split the output B1b+B3b into the first portion B1b and the second portion B3b, provide the first portion B1b to filter 1070a, and provide the second portion B3a to filter 1070b. Filter 1070a can filter out frequencies outside of B1 from the first portion B1b and output the filtered first portion B1b′ to combiner 1080. Filter 1070b can filter out frequencies outside of B3 from the second portion B3b and output the filtered second portion B3b′ to combiner 1030.

Combiner 1030 can combine the filtered first portion B1a′ and the filtered second portion B3b′ and output B1a+B3b to antenna port 330a. Combiner 1080 can combine the filtered first portion B1b′ and the filtered second portion B3a′ and output B1b+B3a to antenna port 330c. Antenna port 330a is associated with transmission to sector 1 230a and antenna port 330c is associated with transmission to sector 2 230b. Therefore, in this example, the first portion B1a and the second portion B3a of the output of dual-band power amplifier 310a are routed to antenna ports associated with different sectors.

FIG. 13 illustrates an example of the radio transmitter 210 of FIG. 8 with a filter box 800 further illustrated by filter box 1200. As illustrated, dual-band power amplifier 310a can output B1a+B3a (which includes a first portion B1a associated with frequency B1 and a second portion B3a associated with frequency B3) and dual-band power amplifier 310b can output B1b+B3b (which includes a first portion B1b associated with frequency B1 and a second portion B3b associated with frequency B3).

Splitter 1110 can split the output B1a+B3a into the first portion B1a and the second portion B3a, provide the first portion B1a to filter 1120a, and provide the second portion B3a to filter 1170b. Filter 1120a can filter out frequencies outside of B1 from the first portion B1a and output the filtered first portion B1a′ to combiner 1130. Filter 1170b can filter out frequencies outside of B3 from the second portion B3a and output the filtered second portion B3a′ to combiner 1180.

Splitter 1160 can split the output B1b+B3b into the first portion B1b and the second portion B3b, provide the first portion B1b to filter 1170a, and provide the second portion B3b to filter 1120b. Filter 1020b can filter out frequencies outside of B3 from the second portion B3b and output the filtered second portion B3a′ to combiner 1130. Filter 1170a can filter out frequencies outside of B1 from the first portion B1b and output the filtered first portion B1b′ to combiner 1180.

Combiner 1130 can combine the filtered first portion B1a′ and the filtered second portion B3b′ and output B1a+B3b to antenna port 330a. Combiner 1180 can combine the filtered first portion B1b′ and the filtered second portion B3a′ and output B1b+B3a to antenna port 330c. Antenna port 330a is associated with transmission to sector 1 230a and antenna port 330c is associated with transmission to sector 2 230b. Therefore, in this example (as in FIG. 12), the first portion B1a and the second portion B3a of the output of dual-band power amplifier 310a are routed to antenna ports associated with different sectors.

In some embodiments, a signal source (e.g., a multi-band transmitter or multi-band amplifier) produces signals in a plurality of frequency bands. The signal source can have an output power limitation that is common for all of the frequency bands (such that if there is less power used at one band, more power can be used in another band). The output from the multi-band power amplifier can be separated (e.g., splitters) so that the signals in different bands can be sent to different signal consumers (e.g., different antennas and/or different devices within different coverage areas). The signal for one band from one source can be combined with a signal for a different band from a different source such that different bands from the same source are transmitted to different consumers/coverage areas. In some examples, a consumer/coverage area receives signals in different bands from different such signal sources.

In additional or alternative embodiments, frequency bands from multi-band power amplifiers are routed to antennas in an interleaved way such that the frequency bands coming from a single multi-band transmitter serves different coverage areas (such as different sectors). Likewise, the frequency bands supplied to a single coverage area may come from different multi-band power amplifiers.

In additional or alternative embodiments, each sector receives each one of the available frequency bands from a different power amplifier. Likewise, each power amplifiers (or multi-band transmitter) supplies each one of its available frequency bands to a different sector.

In some embodiments, a system can include a plurality of wideband signal sources (e.g., multi-band transmitters or multi-band amplifiers), each wideband signal source producing a plurality of frequency bands. The system can further include a plurality of wideband signal consumers (e.g., antennas serving respective coverage areas or sectors), each wideband signal consumer receiving each band of the plurality of frequency bands. The wideband signal consumers can receive the frequency bands from the wideband signal sources. In some examples, the frequency bands are routed from the sources to the consumers such that each consumer receives each frequency band from a source different from any source that it receives any of the other frequency bands from. In additional or alternative examples, the frequency bands may be routed such that for each wideband signal source, each frequency band is routed to a wideband signal consumer different from any wideband signal consumer that any of the other frequency bands of the wideband signal source is routed to.

In additional or alternative embodiments, a wideband signal source may produce a single wideband signal including the plurality of frequency bands. The frequency bands may be separated from each other by frequency selective power splitting. The wideband signal for each frequency band may be further refined by filtering (e.g., to remove still remaining signal components outside of the frequency band). In some examples, the different frequency bands from different wideband signal sources that are provided to a wideband signal consumer may be merged into a single wideband signal by a combiner before being provided to the wideband signal consumer.

In additional or alternative embodiments, when each wideband signal source is subject to a limit of a property (such as a maximum power) common to the plurality of frequency bands, such that the value of the property for each frequency band adds toward the limit, the said routing of the frequency bands enables pooling of the property (such as power pooling) between the consumers. In some examples, a wideband signal consumer may receive, for a frequency band from a wideband signal source, the amount of power available from that wideband signal source that is not used by other wideband signal consumers. In the extreme then, a wideband signal consumer may receive the full wideband signal source power in each of the frequency bands.

In additional or alternative examples, a first band of a first wideband signal source is routed to a first wideband signal consumer and a second band of the first wideband signal source is routed to a second wideband signal consumer, the power provided to the first wideband signal consumer may, in response to an increased need, be increased with respect to the power provided to a second wideband signal consumer by allocating more of the power available from the first wideband signal source to the first band and less to the second band. The first wideband signal source may be an amplifier and allocation of power may be by providing more signal to be transmitted in the first band and less signal to be transmitted in the second band.

In additional or alternative examples, if a need for power in the second consumer is already low, such that the maximum power available from the first wideband signal source is not fully utilized, the spare available power may be allocated to the first band, such that more power is provided to the first band without reducing the power provided to the second band. In this way, available power may be allocated freely between different bands, subject only to the common power limit.

The features and examples described above (e.g., the examples and features in paragraphs [0064]-[0071]) may be inherent in or in addition to the other embodiments of the disclosure as well as in/to one another.

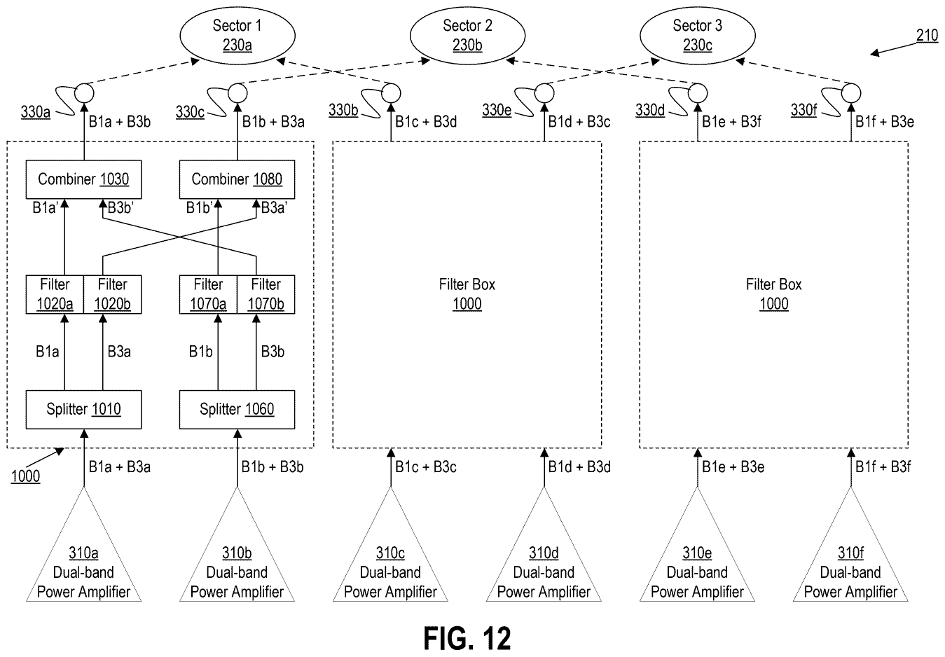

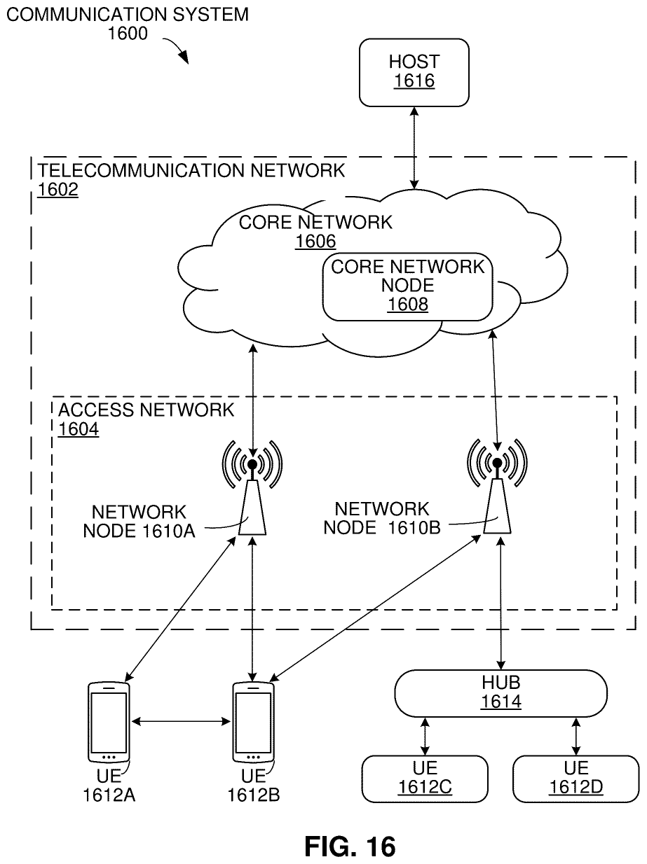

In the description that follows, while the radio transmitter may be any of the radio front-end circuitry 1818, communication interface 1806, network node 1610A, 1610B, core network node 1608, network node 1800, virtualization hardware 2004, virtual machines 2008A, 2008B, or network node 21, the network node 1800 shall be used to describe the functionality of the operations of the radio transmitter. Operations of the network node 1800 (implemented using the structure of the block diagram of FIG. 18) will now be discussed with reference to the flow charts of FIGS. 14-15 according to some embodiments of inventive concepts. For example, modules may be stored in memory 1804 of FIG. 18, and these modules may provide instructions so that when the instructions of a module are executed by respective network node processing circuitry 1802, processing circuitry 1802 performs respective operations of the flow charts.

FIG. 14 illustrates an example of operations performed by a network node. At block 1410, processing circuitry 1802 determines to transmit data towards a first sector of the communications network. At block 1420, processing circuitry 1802 provides a first portion of the data in a first frequency band to a first multi-band power amplifier. At block 1430, processing circuitry 1802 provides a second portion of the data in a second frequency band to a second multi-band power amplifier. At block 1440, a first portion of the output of the first multi-band power amplifier is provided to a first antenna port associated with the first sector. In some embodiments, the first portion of the output of the first multi-band power amplifier is provided to the first antenna port by passing the first portion of the output of the first multi-band power amplifier through a first filter configured to filter out frequencies outside of the first frequency band. In some examples, the filter is a band-pass filter. In some embodiments, processing circuitry 1802 controls and/or instructs the first multi-band power amplifier to provide the first portion of the output of the first multi-band power amplifier to the first antenna port. In additional or alternative embodiments, the first multi-band power amplifier is part of the network node.

At block 1450, a second portion of the output of the first multi-band power amplifier is provided to a second antenna port associated with a second sector. In some embodiments, processing circuitry 1802 controls and/or instructs the first multi-band power amplifier to provide the second portion of the output of the first multi-band power amplifier to the second antenna port. In additional or alternative embodiments, the first multi-band power amplifier is part of the network node.

At block 1460, a portion of the output of the second multi-band power amplifier is provided to the first antenna port associated with the first sector. In some embodiments, providing the portion of the output of the second multi-band power amplifier to the second antenna port includes passing the portion of the output of the second multi-band amplifier through a second filter configured to filter out frequencies outside of the second frequency band. In some examples, the filter is a band-pass filter. In some embodiments, processing circuitry 1802 controls and/or instructs the second multi-band power amplifier to provide the portion output of the second multi-band power amplifier to the first antenna port. In additional or alternative embodiments, the second multi-band power amplifier is part of the network node.

At block 1470, the data is transmitted, via antenna 1810 communicatively coupled to the first antenna port, towards the first sector. In some embodiments, processing circuitry 1802 controls and/or instructs the antenna to transmit the data. In additional or alternative embodiments, the antenna is part of the network node.

FIG. 15 illustrates an example of additional or alternative operations performed by network node. At block 1510, processing circuitry 1802 determines that a first sector of a coverage area of the network node has a greater load than a second sector of the coverage area of the network node. At block 1520, processing circuitry 1802 adjusts an amount of power used by a multi-band power amplifier for a first frequency band relative to an amount of power used by the multi-band power amplifier for a second frequency band. At block 1530, a first portion of the output of the multi-band transmitter that is associated with the first frequency band is provided to a first antenna port associated with the first sector. At block 1540, a second portion of the output of the multi-band transmitter that is associated with the second frequency band is provided to a second antenna port associated with the second sector.

Various operations from the flow charts of FIGS. 14-15 may be optional with respect to some embodiments of nodes and related methods.

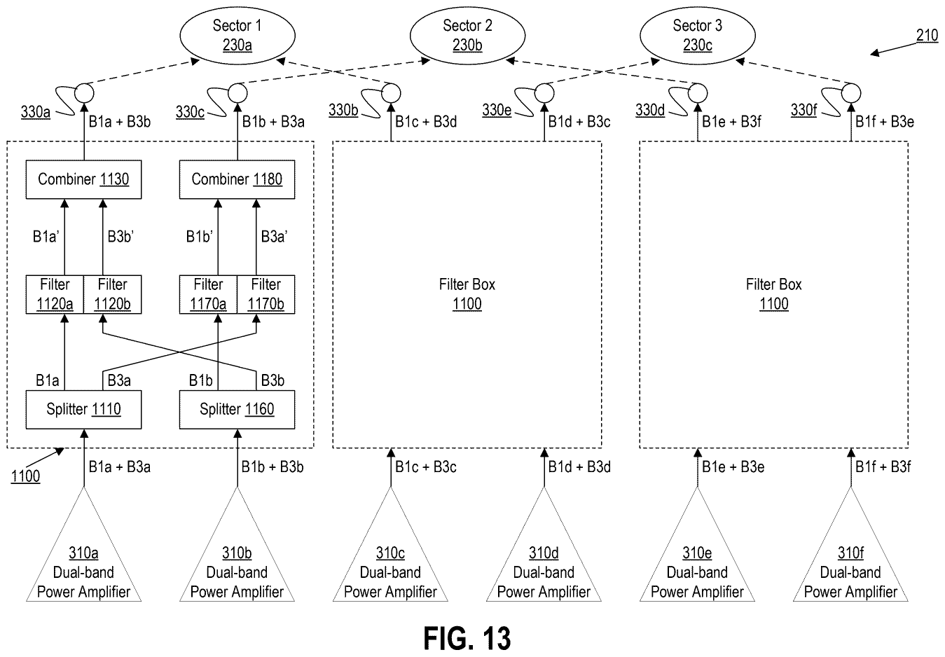

FIG. 16 shows an example of a communication system 1600 in accordance with some embodiments.

In the example, the communication system 1600 includes a telecommunication network 1602 that includes an access network 1604, such as a radio access network (RAN), and a core network 1606, which includes one or more core network nodes 1608. The access network 1604 includes one or more access network nodes, such as network nodes 1610a and 1610b (one or more of which may be generally referred to as network nodes 1610), or any other similar 3^{rd} Generation Partnership Project (3GPP) access node or non-3GPP access point. Moreover, as will be appreciated by those of skill in the art, the network nodes 1610 are not necessarily limited to an implementation in which a radio portion and a baseband portion are supplied and integrated by a single vendor. Thus, it will be understood that the network nodes 1610 may include disaggregated implementations or portions thereof. For example, in some embodiments, the telecommunication network 1602 includes one or more Open-RAN (ORAN) network nodes. An ORAN network node is a node in the telecommunication network 1602 that supports an ORAN specification (e.g., a specification published by the O-RAN Alliance, or any similar organization) and may operate alone or together with other nodes to implement one or more functionalities of any node in the telecommunication network 1602, including one or more network nodes 1610 and/or core network nodes 1608.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time RAN control application (e.g., xApp) or a non-real time RAN automation application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Intents and content-aware notifications described herein may be communicated from a 3GPP network node or an ORAN network node over 3GPP-defined interfaces (e.g., N2, N3) and/or ORAN Alliance-defined interfaces (e.g., A1, O1). Moreover, an ORAN network node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance. The network nodes 1610 facilitate direct or indirect connection of user equipment (UE), such as by connecting wireless devices 1612a, 1612b, 1612c, and 1612d (one or more of which may be generally referred to as UEs 1612) to the core network 1606 over one or more wireless connections. The network nodes 1610 facilitate direct or indirect connection of user equipment (UE), such as by connecting UEs 1612a, 1612b, 1612c, and 1612d (one or more of which may be generally referred to as UEs 1612) to the core network 1606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1600 may include any number of wired or wireless networks, network nodes, UEs, and/or any other components or systems that may facilitate or participate in the communication of data and/or signals whether via wired or wireless connections. The communication system 1600 may include and/or interface with any type of communication, telecommunication, data, cellular, radio network, and/or other similar type of system.

The UEs 1612 may be any of a wide variety of communication devices, including wireless devices arranged, configured, and/or operable to communicate wirelessly with the network nodes 1610 and other communication devices. Similarly, the network nodes 1610 are arranged, capable, configured, and/or operable to communicate directly or indirectly with the UEs 1612 and/or with other network nodes or equipment in the telecommunication network 1602 to enable and/or provide network access, such as wireless network access, and/or to perform other functions, such as administration in the telecommunication network 1602.

In the depicted example, the core network 1606 connects the network nodes 1610 to one or more hosts, such as host 1616. These connections may be direct or indirect via one or more intermediary networks or devices. In other examples, network nodes may be directly coupled to hosts. The core network 1606 includes one more core network nodes (e.g., core network node 1608) that are structured with hardware and software components. Features of these components may be substantially similar to those described with respect to the UEs, network nodes, and/or hosts, such that the descriptions thereof are generally applicable to the corresponding components of the core network node 1608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1616 may be under the ownership or control of a service provider other than an operator or provider of the access network 1604 and/or the telecommunication network 1602, and may be operated by the service provider or on behalf of the service provider. The host 1616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1600 of FIG. 16 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1602 is a cellular network that implements 3GPP standardized features. Accordingly, the telecommunications network 1602 may support network slicing to provide different logical networks to different devices that are connected to the telecommunication network 1602. For example, the telecommunications network 1602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1612 are configured to transmit and/or receive information without direct human interaction. For instance, a UE may be designed to transmit information to the access network 1604 on a predetermined schedule, when triggered by an internal or external event, or in response to requests from the access network 1604. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1614 communicates with the access network 1604 to facilitate indirect communication between one or more UEs (e.g., UE 1612c and/or 1612d) and network nodes (e.g., network node 1610b). In some examples, the hub 1614 may be a controller, router, content source and analytics, or any of the other communication devices described herein regarding UEs. For example, the hub 1614 may be a broadband router enabling access to the core network 1606 for the UEs. As another example, the hub 1614 may be a controller that sends commands or instructions to one or more actuators in the UEs. Commands or instructions may be received from the UEs, network nodes 1610, or by executable code, script, process, or other instructions in the hub 1614. As another example, the hub 1614 may be a data collector that acts as temporary storage for UE data and, in some embodiments, may perform analysis or other processing of the data. As another example, the hub 1614 may be a content source. For example, for a UE that is a VR headset, display, loudspeaker or other media delivery device, the hub 1614 may retrieve VR assets, video, audio, or other media or data related to sensory information via a network node, which the hub 1614 then provides to the UE either directly, after performing local processing, and/or after adding additional local content. In still another example, the hub 1614 acts as a proxy server or orchestrator for the UEs, in particular in if one or more of the UEs are low energy IoT devices.

The hub 1614 may have a constant/persistent or intermittent connection to the network node 1610b. The hub 1614 may also allow for a different communication scheme and/or schedule between the hub 1614 and UEs (e.g., UE 1612c and/or 1612d), and between the hub 1614 and the core network 1606. In other examples, the hub 1614 is connected to the core network 1606 and/or one or more UEs via a wired connection. Moreover, the hub 1614 may be configured to connect to an M2M service provider over the access network 1604 and/or to another UE over a direct connection. In some scenarios, UEs may establish a wireless connection with the network nodes 1610 while still connected via the hub 1614 via a wired or wireless connection. In some embodiments, the hub 1614 may be a dedicated hub—that is, a hub whose primary function is to route communications to/from the UEs from/to the network node 1610b. In other embodiments, the hub 1614 may be a non-dedicated hub—that is, a device which is capable of operating to route communications between the UEs and network node 1610b, but which is additionally capable of operating as a communication start and/or end point for certain data channels.

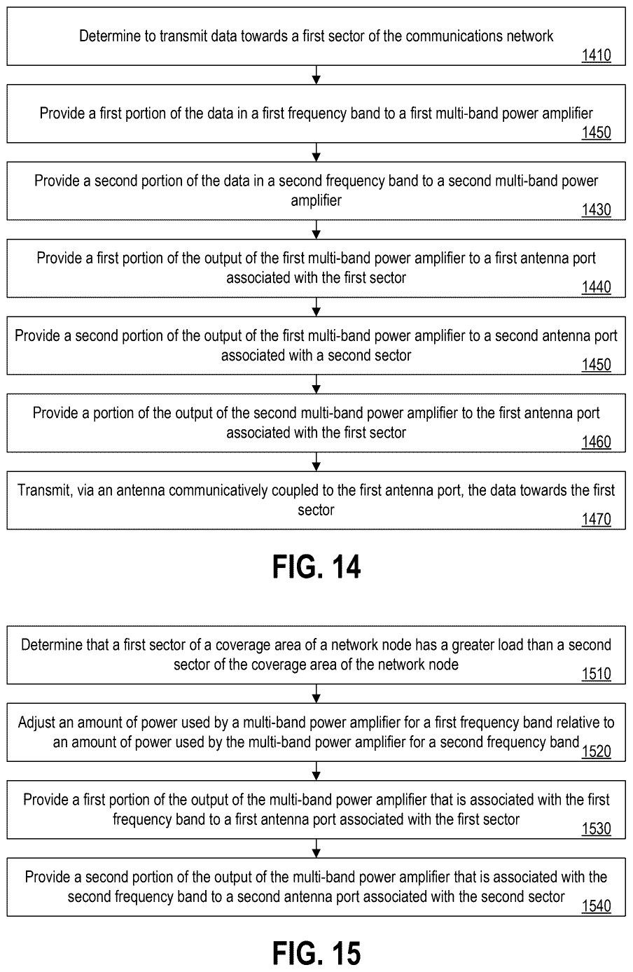

FIG. 17 shows a UE 1700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1700 includes processing circuitry 1702 that is operatively coupled via a bus 1704 to an input/output interface 1706, a power source 1708, a memory 1710, a communication interface 1712, and/or any other component, or any combination thereof. Certain UEs may utilize all or a subset of the components shown in FIG. 17. The level of integration between the components may vary from one UE to another UE. Further, certain UEs may contain multiple instances of a component, such as multiple processors, memories, transceivers, transmitters, receivers, etc.

The processing circuitry 1702 is configured to process instructions and data and may be configured to implement any sequential state machine operative to execute instructions stored as machine-readable computer programs in the memory 1710. The processing circuitry 1702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1702 may include multiple central processing units (CPUs).

In the example, the input/output interface 1706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1708 is structured as a battery or battery pack. Other types of power sources, such as an external power source (e.g., an electricity outlet), photovoltaic device, or power cell, may be used. The power source 1708 may further include power circuitry for delivering power from the power source 1708 itself, and/or an external power source, to the various parts of the UE 1700 via input circuitry or an interface such as an electrical power cable. Delivering power may be, for example, for charging of the power source 1708. Power circuitry may perform any formatting, converting, or other modification to the power from the power source 1708 to make the power suitable for the respective components of the UE 1700 to which power is supplied.

The memory 1710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1710 includes one or more application programs 1714, such as an operating system, web browser application, a widget, gadget engine, or other application, and corresponding data 1716. The memory 1710 may store, for use by the UE 1700, any of a variety of various operating systems or combinations of operating systems.

The memory 1710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1710 may allow the UE 1700 to access instructions, application programs and the like, stored on transitory or non-transitory memory media, to off-load data, or to upload data. An article of manufacture, such as one utilizing a communication system may be tangibly embodied as or in the memory 1710, which may be or comprise a device-readable storage medium.

The processing circuitry 1702 may be configured to communicate with an access network or other network using the communication interface 1712. The communication interface 1712 may comprise one or more communication subsystems and may include or be communicatively coupled to an antenna 1722. The communication interface 1712 may include one or more transceivers used to communicate, such as by communicating with one or more remote transceivers of another device capable of wireless communication (e.g., another UE or a network node in an access network). Each transceiver may include a transmitter 1718 and/or a receiver 1720 appropriate to provide network communications (e.g., optical, electrical, frequency allocations, and so forth). Moreover, the transmitter 1718 and receiver 1720 may be coupled to one or more antennas (e.g., antenna 1722) and may share circuit components, software or firmware, or alternatively be implemented separately.

In the illustrated embodiment, communication functions of the communication interface 1712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1700 shown in FIG. 17.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 18 shows a network node 1800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs), NR NodeBs (gNBs)), O-RAN nodes, or components of an O-RAN node (e.g., intelligent controller, O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1800 includes a processing circuitry 1802, a memory 1804, a communication interface 1806, and a power source 1808. The network node 1800 may be composed of multiple physically separate components (e.g., a NodeB component and a RNC component, or a BTS component and a BSC component, etc.), which may each have their own respective components. In certain scenarios in which the network node 1800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1800 may be configured to support multiple radio access technologies (RATs). In such embodiments, some components may be duplicated (e.g., separate memory 1804 for different RATs) and some components may be reused (e.g., a same antenna 1810 may be shared by different RATs). The network node 1800 may also include multiple sets of the various illustrated components for different wireless technologies integrated into network node 1800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1800.

The processing circuitry 1802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1800 components, such as the memory 1804, to provide network node 1800 functionality.

In some embodiments, the processing circuitry 1802 includes a system on a chip (SOC). In some embodiments, the processing circuitry 1802 includes one or more of radio frequency (RF) transceiver circuitry 1812 and baseband processing circuitry 1814. In some embodiments, the radio frequency (RF) transceiver circuitry 1812 and the baseband processing circuitry 1814 may be on separate chips (or sets of chips), boards, or units, such as radio units and digital units. In alternative embodiments, part or all of RF transceiver circuitry 1812 and baseband processing circuitry 1814 may be on the same chip or set of chips, boards, or units.

The memory 1804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1802. The memory 1804 may store any suitable instructions, data, or information, including a computer program, software, an application including one or more of logic, rules, code, tables, and/or other instructions capable of being executed by the processing circuitry 1802 and utilized by the network node 1800. The memory 1804 may be used to store any calculations made by the processing circuitry 1802 and/or any data received via the communication interface 1806. In some embodiments, the processing circuitry 1802 and memory 1804 is integrated.

The communication interface 1806 is used in wired or wireless communication of signaling and/or data between a network node, access network, and/or UE. As illustrated, the communication interface 1806 comprises port(s)/terminal(s) 1816 to send and receive data, for example to and from a network over a wired connection. The communication interface 1806 also includes radio front-end circuitry 1818 that may be coupled to, or in certain embodiments a part of, the antenna 1810. Radio front-end circuitry 1818 comprises filters 1820 and amplifiers 1822. The radio front-end circuitry 1818 may be connected to an antenna 1810 and processing circuitry 1802. The radio front-end circuitry may be configured to condition signals communicated between antenna 1810 and processing circuitry 1802. The radio front-end circuitry 1818 may receive digital data that is to be sent out to other network nodes or UEs via a wireless connection. The radio front-end circuitry 1818 may convert the digital data into a radio signal having the appropriate channel and bandwidth parameters using a combination of filters 1820 and/or amplifiers 1822. The radio signal may then be transmitted via the antenna 1810. Similarly, when receiving data, the antenna 1810 may collect radio signals which are then converted into digital data by the radio front-end circuitry 1818. The digital data may be passed to the processing circuitry 1802. In other embodiments, the communication interface may comprise different components and/or different combinations of components.

In certain alternative embodiments, the network node 1800 does not include separate radio front-end circuitry 1818, instead, the processing circuitry 1802 includes radio front-end circuitry and is connected to the antenna 1810. Similarly, in some embodiments, all or some of the RF transceiver circuitry 1812 is part of the communication interface 1806. In still other embodiments, the communication interface 1806 includes one or more ports or terminals 1816, the radio front-end circuitry 1818, and the RF transceiver circuitry 1812, as part of a radio unit (not shown), and the communication interface 1806 communicates with the baseband processing circuitry 1814, which is part of a digital unit (not shown).

The antenna 1810 may include one or more antennas, or antenna arrays, configured to send and/or receive wireless signals. The antenna 1810 may be coupled to the radio front-end circuitry 1818 and may be any type of antenna capable of transmitting and receiving data and/or signals wirelessly. In certain embodiments, the antenna 1810 is separate from the network node 1800 and connectable to the network node 1800 through an interface or port.

The antenna 1810, communication interface 1806, and/or the processing circuitry 1802 may be configured to perform any receiving operations and/or certain obtaining operations described herein as being performed by the network node. Any information, data and/or signals may be received from a UE, another network node and/or any other network equipment. Similarly, the antenna 1810, the communication interface 1806, and/or the processing circuitry 1802 may be configured to perform any transmitting operations described herein as being performed by the network node. Any information, data and/or signals may be transmitted to a UE, another network node and/or any other network equipment.

The power source 1808 provides power to the various components of network node 1800 in a form suitable for the respective components (e.g., at a voltage and current level needed for each respective component). The power source 1808 may further comprise, or be coupled to, power management circuitry to supply the components of the network node 1800 with power for performing the functionality described herein. For example, the network node 1800 may be connectable to an external power source (e.g., the power grid, an electricity outlet) via an input circuitry or interface such as an electrical cable, whereby the external power source supplies power to power circuitry of the power source 1808. As a further example, the power source 1808 may comprise a source of power in the form of a battery or battery pack which is connected to, or integrated in, power circuitry. The battery may provide backup power should the external power source fail.

Embodiments of the network node 1800 may include additional components beyond those shown in FIG. 18 for providing certain aspects of the network node's functionality, including any of the functionality described herein and/or any functionality necessary to support the subject matter described herein. For example, the network node 1800 may include user interface equipment to allow input of information into the network node 1800 and to allow output of information from the network node 1800. This may allow a user to perform diagnostic, maintenance, repair, and other administrative functions for the network node 1800.

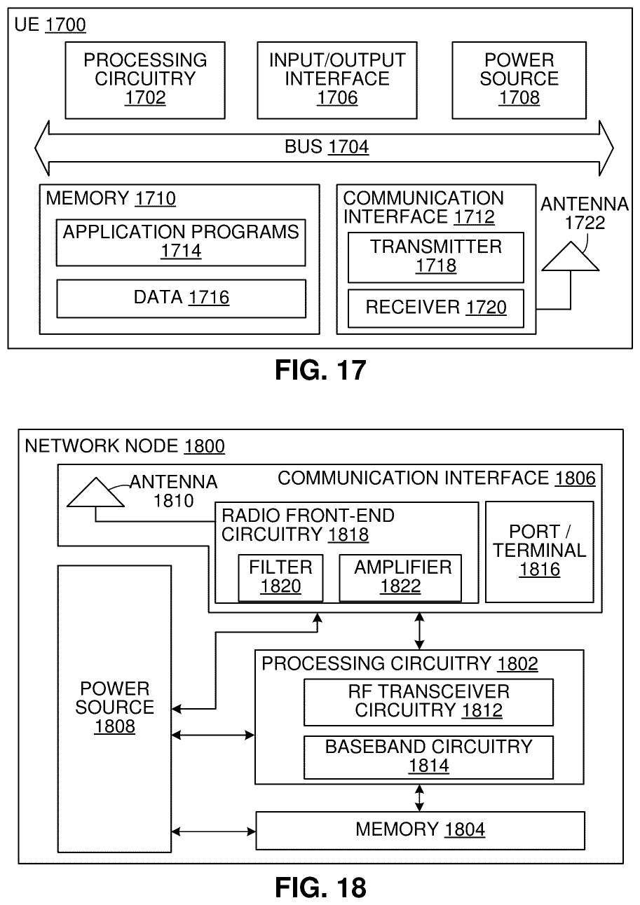

FIG. 19 is a block diagram of a host 1900, which may be an embodiment of the host 1616 of FIG. 16, in accordance with various aspects described herein. As used herein, the host 1900 may be or comprise various combinations hardware and/or software, including a standalone server, a blade server, a cloud-implemented server, a distributed server, a virtual machine, container, or processing resources in a server farm. The host 1900 may provide one or more services to one or more UEs.

The host 1900 includes processing circuitry 1902 that is operatively coupled via a bus 1904 to an input/output interface 1906, a network interface 1908, a power source 1910, and a memory 1912. Other components may be included in other embodiments. Features of these components may be substantially similar to those described with respect to the devices of previous figures, such as FIGS. 17 and 18, such that the descriptions thereof are generally applicable to the corresponding components of host 1900.

The memory 1912 may include one or more computer programs including one or more host application programs 1914 and data 1916, which may include user data, e.g., data generated by a UE for the host 1900 or data generated by the host 1900 for a UE. Embodiments of the host 1900 may utilize only a subset or all of the components shown. The host application programs 1914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1914 may also provide for user authentication and licensing checks and may periodically report health, routes, and content availability to a central node, such as a device in or on the edge of a core network. Accordingly, the host 1900 may select and/or indicate a different host for over-the-top services for a UE. The host application programs 1914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

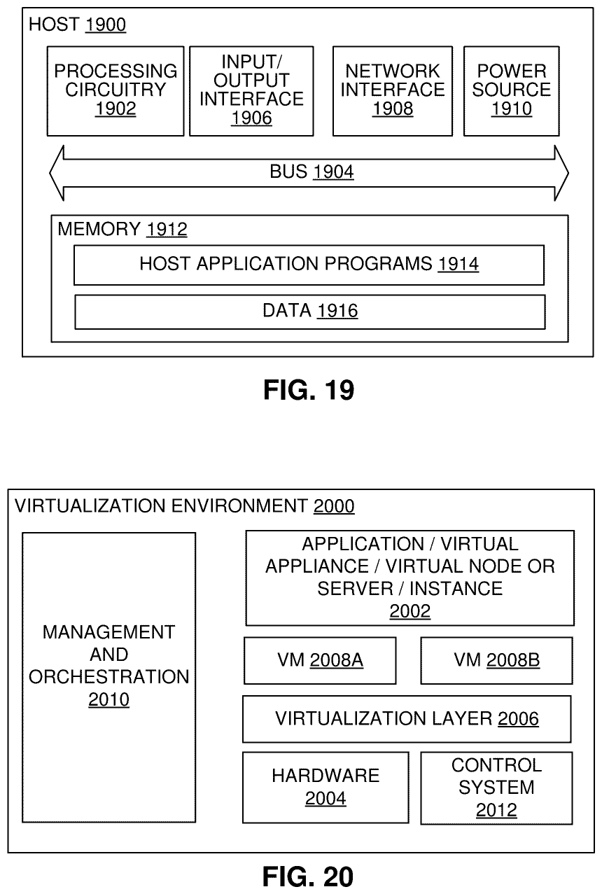

FIG. 20 is a block diagram illustrating a virtualization environment 2000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 2000 includes components defined by the O-RAN Alliance, such as an O-Cloud environment orchestrated by a Service Management and Orchestration Framework via an O-2 interface.

Applications 2002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2006 (also referred to as hypervisors or virtual machine monitors (VMMs)), provide VMs 2008a and 2008b (one or more of which may be generally referred to as VMs 2008), and/or perform any of the functions, features and/or benefits described in relation with some embodiments described herein. The virtualization layer 2006 may present a virtual operating platform that appears like networking hardware to the VMs 2008.

The VMs 2008 comprise virtual processing, virtual memory, virtual networking or interface and virtual storage, and may be run by a corresponding virtualization layer 2006. Different embodiments of the instance of a virtual appliance 2002 may be implemented on one or more of VMs 2008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2008 may be a software implementation of a physical machine that runs programs as if they were executing on a physical, non-virtualized machine. Each of the VMs 2008, and that part of hardware 2004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2008 on top of the hardware 2004 and corresponds to the application 2002.

Hardware 2004 may be implemented in a standalone network node with generic or specific components. Hardware 2004 may implement some functions via virtualization. Alternatively, hardware 2004 may be part of a larger cluster of hardware (e.g. such as in a data center or CPE) where many hardware nodes work together and are managed via management and orchestration 2010, which, among others, oversees lifecycle management of applications 2002. In some embodiments, hardware 2004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2012 which may alternatively be used for communication between hardware nodes and radio units.

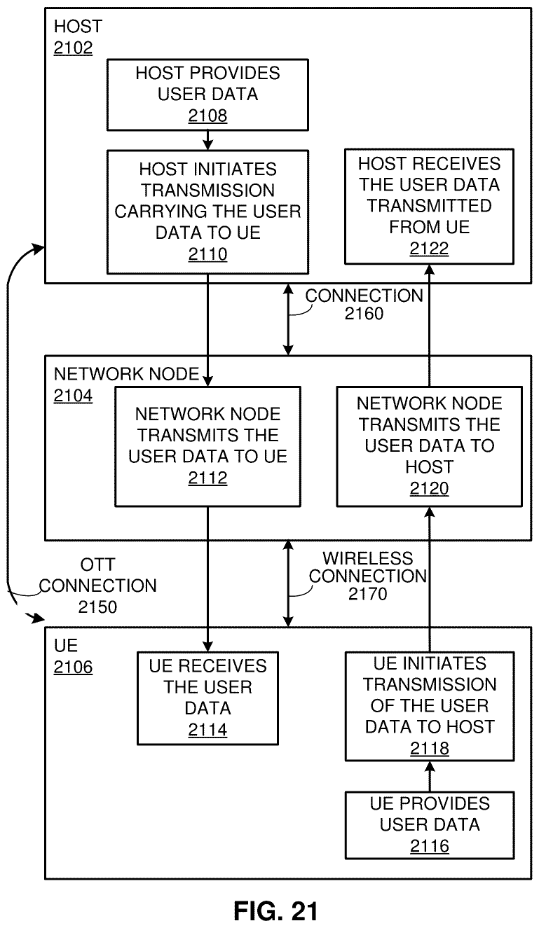

FIG. 21 shows a communication diagram of a host 2102 communicating via a network node 2104 with a UE 2106 over a partially wireless connection in accordance with some embodiments. Example implementations, in accordance with various embodiments, of the UE (such as a UE 1612a of FIG. 16 and/or UE 1700 of FIG. 17), network node (such as network node 1610a of FIG. 16 and/or network node 1800 of FIG. 18), and host (such as host 1616 of FIG. 16 and/or host 1900 of FIG. 19) discussed in the preceding paragraphs will now be described with reference to FIG. 21.

Like host 1900, embodiments of host 2102 include hardware, such as a communication interface, processing circuitry, and memory. The host 2102 also includes software, which is stored in or accessible by the host 2102 and executable by the processing circuitry. The software includes a host application that may be operable to provide a service to a remote user, such as the UE 2106 connecting via an over-the-top (OTT) connection 2150 extending between the UE 2106 and host 2102. In providing the service to the remote user, a host application may provide user data which is transmitted using the OTT connection 2150.

The network node 2104 includes hardware enabling it to communicate with the host 2102 and UE 2106. The connection 2160 may be direct or pass through a core network (like core network 1606 of FIG. 16) and/or one or more other intermediate networks, such as one or more public, private, or hosted networks. For example, an intermediate network may be a backbone network or the Internet.

The UE 2106 includes hardware and software, which is stored in or accessible by UE 2106 and executable by the UE's processing circuitry. The software includes a client application, such as a web browser or operator-specific “app” that may be operable to provide a service to a human or non-human user via UE 2106 with the support of the host 2102. In the host 2102, an executing host application may communicate with the executing client application via the OTT connection 2150 terminating at the UE 2106 and host 2102. In providing the service to the user, the UE's client application may receive request data from the host's host application and provide user data in response to the request data. The OTT connection 2150 may transfer both the request data and the user data. The UE's client application may interact with the user to generate the user data that it provides to the host application through the OTT connection 2150.

The OTT connection 2150 may extend via a connection 2160 between the host 2102 and the network node 2104 and via a wireless connection 2170 between the network node 2104 and the UE 2106 to provide the connection between the host 2102 and the UE 2106. The connection 2160 and wireless connection 2170, over which the OTT connection 2150 may be provided, have been drawn abstractly to illustrate the communication between the host 2102 and the UE 2106 via the network node 2104, without explicit reference to any intermediary devices and the precise routing of messages via these devices.

As an example of transmitting data via the OTT connection 2150, in step 2108, the host 2102 provides user data, which may be performed by executing a host application. In some embodiments, the user data is associated with a particular human user interacting with the UE 2106. In other embodiments, the user data is associated with a UE 2106 that shares data with the host 2102 without explicit human interaction. In step 2110, the host 2102 initiates a transmission carrying the user data towards the UE 2106. The host 2102 may initiate the transmission responsive to a request transmitted by the UE 2106. The request may be caused by human interaction with the UE 2106 or by operation of the client application executing on the UE 2106. The transmission may pass via the network node 2104, in accordance with the teachings of the embodiments described throughout this disclosure. Accordingly, in step 2112, the network node 2104 transmits to the UE 2106 the user data that was carried in the transmission that the host 2102 initiated, in accordance with the teachings of the embodiments described throughout this disclosure. In step 2114, the UE 2106 receives the user data carried in the transmission, which may be performed by a client application executed on the UE 2106 associated with the host application executed by the host 2102.

In some examples, the UE 2106 executes a client application which provides user data to the host 2102. The user data may be provided in reaction or response to the data received from the host 2102. Accordingly, in step 2116, the UE 2106 may provide user data, which may be performed by executing the client application. In providing the user data, the client application may further consider user input received from the user via an input/output interface of the UE 2106. Regardless of the specific manner in which the user data was provided, the UE 2106 initiates, in step 2118, transmission of the user data towards the host 2102 via the network node 2104. In step 2120, in accordance with the teachings of the embodiments described throughout this disclosure, the network node 2104 receives user data from the UE 2106 and initiates transmission of the received user data towards the host 2102. In step 2122, the host 2102 receives the user data carried in the transmission initiated by the UE 2106.

One or more of the various embodiments improve the performance of OTT services provided to the UE 2106 using the OTT connection 2150, in which the wireless connection 2170 forms the last segment. More precisely, the teachings of these embodiments may enable power pooling between sectors for radio transceivers that use multi-band transmitters. This can lead to better use of the total power of the radio and in turn lead to smaller radios with better efficiency, lower power consumption, and improved sustainability (e.g., less of an environmental footprint).

In an example scenario, factory status information may be collected and analyzed by the host 2102. As another example, the host 2102 may process audio and video data which may have been retrieved from a UE for use in creating maps. As another example, the host 2102 may collect and analyze real-time data to assist in controlling vehicle congestion (e.g., controlling traffic lights). As another example, the host 2102 may store surveillance video uploaded by a UE. As another example, the host 2102 may store or control access to media content such as video, audio, VR or AR which it can broadcast, multicast or unicast to UEs. As other examples, the host 2102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2150 between the host 2102 and UE 2106, in response to variations in the measurement results. The measurement procedure and/or the network functionality for reconfiguring the OTT connection may be implemented in software and hardware of the host 2102 and/or UE 2106. In some embodiments, sensors (not shown) may be deployed in or in association with other devices through which the OTT connection 2150 passes; the sensors may participate in the measurement procedure by supplying values of the monitored quantities exemplified above, or supplying values of other physical quantities from which software may compute or estimate the monitored quantities. The reconfiguring of the OTT connection 2150 may include message format, retransmission settings, preferred routing etc.; the reconfiguring need not directly alter the operation of the network node 2104. Such procedures and functionalities may be known and practiced in the art. In certain embodiments, measurements may involve proprietary UE signaling that facilitates measurements of throughput, propagation times, latency and the like, by the host 2102. The measurements may be implemented in that software causes messages to be transmitted, in particular empty or ‘dummy’ messages, using the OTT connection 2150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A multi-band transmitter in a communications network comprising:
a first antenna port associated with a first sector of a coverage area;
a second antenna port associated with a second sector of the coverage area, the second antenna port being different from the first antenna port, and the second sector being different from the first sector; and
a multi-band power amplifier configured to generate an output that includes:
a first portion that is associated with a first frequency band and that is routed to the first antenna port; and
a second portion that is associated with a second frequency band and that is routed to the second antenna port, the second frequency band being different than the first frequency band.

2. The multi-band transmitter of claim 1, further comprises:
a filter box including:
an input port communicatively coupled to the multi-band power amplifier and configured to receive the output of the multi-band power amplifier;
a first output port communicatively coupled to the first antenna port and configured to provide the first portion of the output to the first antenna port; and
a second output port communicatively coupled to the second antenna port and configured to provide the second portion of the output to the second antenna port.

3. The multi-band transmitter of claim 2, wherein the filter box further comprises:
a splitter communicatively coupled to the input port and configured to split the output into the first portion of the output and the second portion of the output;
a first filter communicatively coupled to the splitter and configured to filter out frequencies outside of the first frequency band from the first portion of the output;
a second filter communicatively coupled to the splitter and configured to filter out frequencies outside of the second frequency band from the second portion of the output;
a first combiner communicatively coupled to the first filter and configured to provide a first signal based on the first portion of the output to the first output port; and
a second combiner communicatively coupled to the second filter and configured to provide a second signal based on the second portion of the output to the second output port.

4. The multi-band transmitter of claim 3, wherein the first filter and the second filter each comprise a band-pass filter.

5. The multi-band transmitter of claim 3, wherein the multi-band power amplifier is a first multi-band power amplifier,
the multi-band transmitter further comprising:
a second multi-band power amplifier configured to generate an output that includes a first portion that is associated with the first frequency band and that is routed to the second antenna port via the filter box.

6. The multi-band transmitter of claim 5, wherein the input port is a first input port,
wherein the splitter is a first splitter,
wherein the filter box further includes:
a second input port communicatively coupled to the second multi-band power amplifier and configured to receive the output of the second multi-band power amplifier;
a second splitter communicatively coupled to the second input port and configured to provide the first portion of the output of the second multi-band power amplifier to a third filter and a second portion of the output of the second multi-band power amplifier to a fourth filter;
the third filter communicatively coupled to the second splitter and configured to filter out frequencies outside of the first frequency band from the first portion of the output of the second multi-band power amplifier; and
the fourth filter communicatively coupled to the second splitter and configured to filter out frequencies outside of the second frequency band from the second portion of the output of the second multi-band power amplifier,
wherein the first combiner is communicatively coupled to the fourth filter and further configured to provide the first signal based on the second portion of the output of the second multi-band power amplifier, and
wherein the second combiner is further configured to generate the second signal based on the second portion of the output of the first multi-band power amplifier and the first portion of the output of the second multi-band power amplifier.

7. The multi-band transmitter of claim 5, wherein the output of the second multi-band power amplifier further includes a second portion that is associated with the second frequency band and that is routed to the first antenna port via the filter box.

8. The multi-band transmitter of claim 5, further comprises:
a third antenna port that is different from the first antenna port and the second antenna port,
wherein the output of the second multi-band power amplifier further includes a second portion that is associated with the second frequency band and that is routed to the third antenna port.

9. The multi-band transmitter of claim 5, further comprising:
processing circuitry; and
memory having instructions stored therein that are executable by the processing circuitry to cause the multi-band transmitter to perform operations comprising:
determining to transmit data towards a sector associated with the first antenna port of the communications network;
providing a first portion of the data in the first frequency band to the first multi-band power amplifier; and
providing a second portion of the data in the second frequency band to the second multi-band power amplifier.

10. The multi-band transmitter of claim 1, further comprising:
processing circuitry; and
memory having instructions stored therein that are executable by the processing circuitry to cause the multi-band transmitter to perform operations comprising:
determining that the first sector of the coverage area of the multi-band transmitter has a greater load than the second sector of the coverage area of the multi-band transmitter;
adjusting an amount of power used by a multi-band power amplifier for a first frequency band relative to an amount of power used by the multi-band power amplifier for a second frequency band based on determining that the first sector has a greater load than the second sector.

11. The multi-band transmitter of claim 1, further comprising:
a first antenna communicatively coupled to the first antenna port and configured to communicate with the first sector of the coverage area of the multi-band transmitter; and
a second antenna communicatively coupled to the second antenna port and configured to communicate with the second sector of the coverage area of the multi-band transmitter, the first sector being different than the second sector.

12. A multi-band transmitter comprising:
a plurality of wideband signal sources each configured to provide a plurality of frequency bands; and
routing circuitry configured to route each frequency band of the plurality of frequency bands associated with one of the plurality of wideband signal sources to a different wideband signal consumer, each of the different wideband signal consumers being associated with a different coverage area of the multi-band transmitter.

13. The multi-band transmitter of claim 12, wherein the plurality of wideband signal sources comprise a plurality of multi-band power amplifiers that each produce a signal that includes the plurality of frequency bands, and
wherein the routing circuitry comprises:
a plurality of splitters that are each configured to split each signal into the plurality of frequency bands; and
a plurality of combiners that are each configured to combine frequency bands from different signals into a combined signal that is provided to one of the different wideband signal consumers.

14. The multi-band transmitter of claim 12, wherein the routing circuitry comprises:
a plurality of filters that are each configured to filter out frequencies outside of one frequency band of the plurality of frequency bands.

15. The multi-band transmitter of claim 12, wherein the routing circuitry is configured to:
route a first frequency band of the plurality of frequency bands provided by a first wideband signal source of the plurality of wideband signal sources to a first wideband consumer of the different wideband signal consumers, and
route a second frequency band of the plurality of frequency bands provided by the first wideband signal source to a second wideband signal consumer of the different wideband signal consumers.

16. The multi-band transmitter of claim 15, wherein the plurality of wideband signal sources are configured to provide more power to the first wideband signal consumer relative to the power provided to a second wideband signal consumer by allocating more of the power available from the first wideband signal source to the first frequency band and less to the second frequency band.

17. The multi-band transmitter of claim 12, wherein the plurality of wideband signal sources comprise a plurality of multi-band power amplifiers, and
wherein the different wideband signal consumers comprise a plurality of antennas or antenna ports.

18. A method of operating a network node in a communications network, the method comprising:
determining to transmit data towards a sector of the communications network;
providing a first portion of the data in a first frequency band to a first multi-band power amplifier; and
providing a second portion of the data in a second frequency band to a second multi-band power amplifier, the second frequency band being different than the first frequency band and the second multi-band power amplifier being different than the first multi-band power amplifier.

19. The method of claim 18, wherein the sector is a first sector of the communications network,
the method further comprising:
responsive to providing the first portion of the data to the first multi-band power amplifier and responsive to providing the second portion of the data to the second multi-band power amplifier, providing a first signal associated with a first portion of a output of the first multi-band power amplifier and a portion of an output of the second multi-band power amplifier to a first antenna port associated with the first sector; and
responsive to providing the first portion of the data to the first multi-band power amplifier, providing a second signal associated with a second portion of the output of the first multi-band power amplifier to a second antenna port associated with a second sector of the communications network that is different than the first sector.

20. The method of claim 19, wherein providing the first signal to the first antenna port comprises:
splitting, via a first splitter, the output of the first multi-band power amplifier into the first portion and the second portion;
filtering, via a first filter, the first portion of the output of the first multi-band power amplifier to remove frequencies outside of the first frequency band;
splitting, via a second splitter, the output of the second multi-band power amplifier to generate the portion of the output of the second multi-band power amplifier;
filtering, via a second filter, the portion of the output of the second multi-band power amplifier to remove frequencies outside of the second frequency band; and
generating, via a combiner, the first signal based on an output of the first filter and an output of the second filter.

21. The method of claim 20, wherein the first filter and the second filter each comprise a band-pass filter.

22. The method of claim 19, further comprising:
responsive to providing the first signal to the first antenna port, transmitting, via an antenna communicatively coupled to the first antenna port, the data towards the first sector.

23. A method of operating a network node to pool power between a plurality of multi-band power amplifiers, the method further comprising:
determining that a first sector of a coverage area of the network node has a greater load than a second sector of the coverage area of the network node; and
adjusting an amount of power used by a multi-band power amplifier for a first frequency band relative to an amount of power used by the multi-band power amplifier for a second frequency band based on determining that the first sector has a greater load than the second sector.

24. The method of claim 23, further comprising:
providing a first portion of an output of the multi-band power amplifier that is associated with the first frequency band to a first antenna port associated with the first sector; and
providing a second portion of the output of the multi-band power amplifier that is associated with the second frequency band to a second antenna port associated with the second sector, the first antenna port being different from the second antenna port.

25.-28. (canceled)
